(19) United States
(12) Patent Application Publication
(10) Pub. No.: US 2023/0162314 A1
(43) Pub. Date: May 25, 2023

(54) DATA FEED MANAGEMENT ARCHITECTURE

(71) Applicant: PointsBet Pty Ltd., Cremorne (AU)

(72) Inventor: Simon Darcy, Cremorne (AU)

(21) Appl. No.: 17/531,290

(22) Filed: Nov. 19, 2021

(51) Int. Cl. G06Q 50/34; G07F 17/32

(52) U.S. Cl. CPC G06Q 50/34; G07F 17/3237; G07F 17/3288

(57) ABSTRACT

Methods, apparatus, systems, and articles of manufacture are disclosed to manage and convert a data feed into odds, market data, and associated betting opportunities. An example apparatus includes: odds generator circuitry to generate odds from a data feed using at least one model; data feed management circuitry to process data including the odds to apply one or more rules to generate at least a first data set including wagering opportunities for a first region and a second data set including wagering opportunities for a second region; and a plurality of region data stores including a first region data store to process and store the first data set and provide a first region update to the odds generator circuitry and a second region data store to process and store the second data set and provide a second region update to the odds generator circuitry.

### FIELD OF THE DISCLOSURE

This disclosure relates generally to a data feed management architecture, and, more particularly, to methods, apparatus, and articles of manufacture to process and convert a data feed into odds and associated market data to enable wagering opportunities in a closed loop system.

### BACKGROUND

Data management is a highly complex field of technology and, accordingly, a great deal of research that is undertaken in computer science and data science has been dedicated to a broad range of topics related to managing and controlling access to data. Some example diverse areas that have attracted considerable research include: efficient data processing methods, data compression technologies, data searching methodologies, data security techniques and data storage technologies. These a just a few of the areas that have attracted considerable commercial research.

However, data can be used in non-traditional applications as well. Sports betting involves predicting an outcome or occurrence in a sporting event and placing a wager on that outcome or occurrence. Sporting events can include a variety of sports such as football, basketball, baseball, hockey, soccer, auto racing, horse racing, boxing, tennis, etc. An odds of winning or success are associated with each outcome or occurrence. The odds represent a ratio of an amount won to a wager or stake made. As such, the odds represent the probability of a given outcome or occurrence.

Odds are generated based on data, such as betting data, market data, historical data, etc. Data is used to define the odds based on a probability of winning, historical results, possible future outcomes, etc. The odds represent a prediction of how likely it is for a certain event to occur (e.g., that a certain team will win or lose, a score will occur, another event will occur, etc.). Prediction of the event according to the odds becomes a bet. The odds can also be used to determine an amount of payout to a winner of an associated bet.

The odds are used by sportsbooks or other bookmakers to set a payout for winning/success and can be used by bettors in evaluating whether and how to place their wager(s). When setting odds, a bookmaker may be limited or constrained by regulation, guideline, etc. Odds can be represented as a positive value, a negative value, a fractional value, a decimal value, a ratio, etc. Often, odds and betting are associated with sporting events, such as basketball, racing, football, baseball, tennis, soccer, boxing, mixed martial arts, esports, etc.

### BRIEF DESCRIPTION OF THE DRAWINGS

FIG. 1 is a schematic illustration of a known data feed.

FIG. 2 is a schematic illustration of an improved data feed management architecture.

FIG. 3 is an example model used with the architecture of FIG. 2.

FIG. 4 depicts a data flow diagram between elements of the example architecture of FIG. 2.

FIG. 5 is a flowchart representative of example machine readable instructions that may be executed by example processor circuitry to implement the example architecture of FIG. 2 and the associated data flow of FIG. 4.

FIG. 6 is a block diagram of an example processing platform including processor circuitry structured to execute the example machine readable instructions of FIG. 5 to implement the example architecture of FIG. 2 and the associated data flow of FIG. 4.

FIG. 7 is a block diagram of an example implementation of the processor circuitry of FIG. 6.

FIG. 8 is a block diagram of another example implementation of the processor circuitry of FIG. 6.

FIG. 9 is a block diagram of an example software distribution platform (e.g., one or more servers) to distribute software (e.g., software corresponding to the example machine readable instructions of FIG. 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts. As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/- 1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

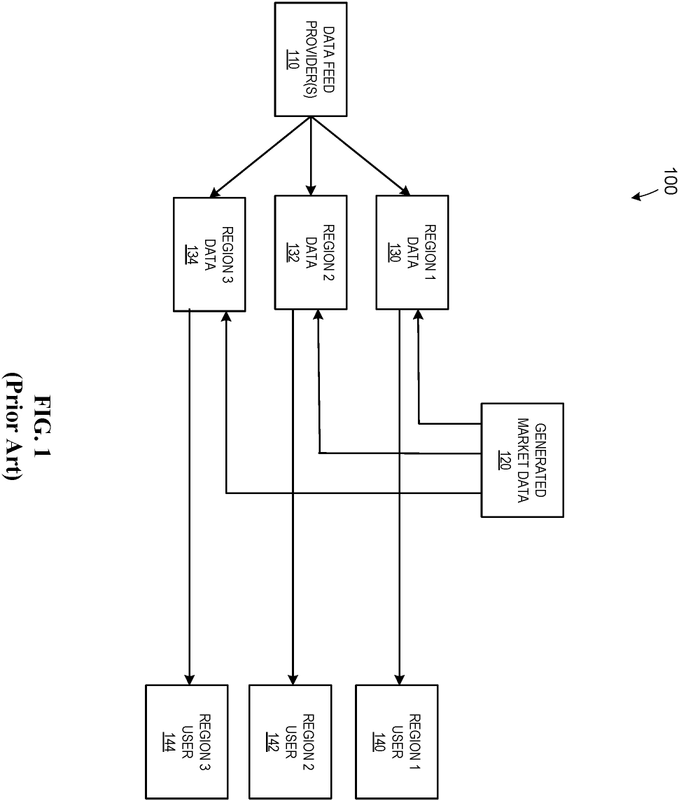

FIG. 1 illustrates a prior approach to data feed management using an example data feed architecture 100. In the example of FIG. 1, one or more third party data feed providers 110 and internally generated market data 120 form a plurality of regional data sets 130-134 that are provided to respective regional users 140-144. Each separate data feed 110 is sourced from a third party provider, and each data feed 110 serves a particular region 140-144. Separate data feeds 110 are expensive. Additionally, a change to one region’s data 130-134 does not propagate to another region’s data 130-134. The architecture 100 is unable to provide such connectivity and interactivity because each region data set 130-134 is separate.

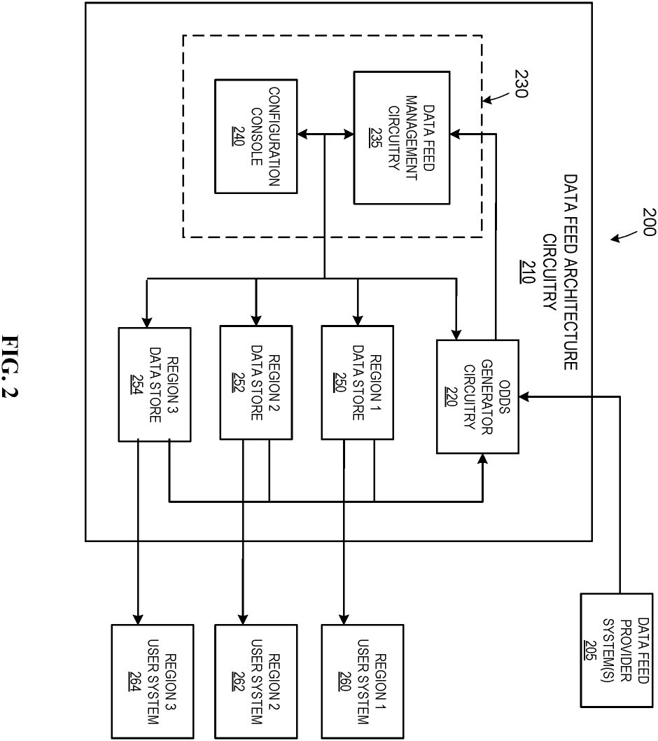

FIG. 2 illustrates a new data feed management architecture or system 200 that remedies the many deficiencies of the prior approach 100. In the example of FIG. 2, data feed architecture circuitry 210 incorporates an odds generator 220 and enables synchronized distribution of market data from the odds generator circuitry 220 to a plurality of regions/locations. Additionally, regional updates are pushed back to the odds generator circuitry 220, which updates odds and associated market data information to provide to the plurality of regions/locations. As such, data can be shared and adjusted between regions, and region(s) can provide updates to impact themselves and other regions(s).

The example data feed management system 200 of FIG. 2 includes the data feed architecture circuitry 210, which includes the odds generator circuitry 220 (e.g., also referred to as an odds factory) and conversion circuitry 230 to convert odds data generated by the odds generator circuitry 220 from market data provided by one or more data feed provider systems 205. The example conversion circuitry 230 includes data feed management circuitry 235 and a configuration console 240. The example data feed architecture circuitry 210 also includes a plurality of region data stores 250-254, which store and provide data from the conversion circuitry 230 back to the odds generator circuitry 220 and to a plurality of regional user systems 260-264.

In certain examples, all or part of the data feed architecture circuitry 210 can be implemented on a cloud server, a remote server, and/or other computing device to receive updates from the data feed providers 205 and provide updates to the region user systems 260-264. In certain examples, data feed providers 205 and region data stores 250-254 can operate on edge and/or local devices with the odds generator circuitry 220 and the conversion circuitry 230 in the cloud. In certain examples, the configuration console 240 is and/or communicates with a local device to receive external input such as configuration information, local system input, user input, etc.

In operation, market data from one or more data provider(s) 205 is provided to the odds generator circuitry 220. A market (also referred to as a betting market) is representative of an opportunity to place a bet/wager on a sporting event. As such, markets can include American football, European football, Chinese table tennis, Indian cricket, American basketball, etc. For example, a data provider 205 may generate a data feed of Russian table tennis matches, and another data provider 205 may generate a data feed of Australian rules football games. The data feed provides information regarding the game and/or other event such as score, player statistics, etc. The data feed can include historical information, future prediction, in-play or live data from an ongoing event, etc. The data feed(s) from the one or more data providers 205 can provide market data regarding a single market, hundreds of markets, etc., depending on membership/subscriber base, region, location, etc. The data feed(s) provide up-to-date information regarding sporting and/or other events available for wagering in the particular region(s) and/or facilities (e.g., sportsbooks, casinos, applications, etc.).

The incoming data is processed by the odds generator circuitry 220 to extract information from the market data, model the data, extrapolate or predict from the data, etc. As such, the odds generator circuitry 220 can set odds for upcoming and/or in-play (e.g., live) events based on the data feed(s) from the provider(s) 205. The odds are used to set an opportunity for a bet/wager on an event, a player, a score, another outcome/occurrence, etc.

In certain examples, the odds generator circuitry 220 can apply one or more statistical models, quantitative models, artificial intelligence models, etc., to the data feed to adjust the data feed and associated odds for the conversion circuitry 230, which prepares the data and associated odds for distribution to a plurality of regional data stores 250-254, which update regional systems 260-264 to enable bets to be placed and processed. Regional updates from the regional data stores 250-254 also feed back to the odds generator circuitry 220 to update the model(s) used to process the market data from the data feed provider(s) 205, for example.

For example, the data feed management circuitry 235 processes an output of the odds generator circuitry 220 according to one or more rules configured in the data feed management circuitry 235 and/or provided from external input via the configuration console 240 to govern routing of data, filtering of data, adjustment of data, further processing of data, etc., according to region, market, and/or other criterion. For example, data from the odds generator circuitry 220 is routed by the data feed management circuitry 235 to one or more of the region data stores 250-254 according to rules executed by the data feed management circuitry 235 according to one or more criterion, stipulated condition, and/or other factor set via the configuration console 240 and/or otherwise configured in the data feed management circuitry 235. Such criterion, condition, etc., can govern which data is to be provided to which region(s), bounds or limits on data provided to a region, factor or other adjustment to be applied to data for a region, alert or indicator to be associated with data for a region, etc.

The data feed management circuity 235 can thus be configured by the configuration console 240 to process incoming data from the odds generator circuitry 220 and accordingly route resulting data to corresponding region data store(s) 250-254. In certain examples, the configuration console 240 can set parameter(s), setting(s), other configuration, etc., of the odds generator circuitry 220 and/or can provide feedback to the odds generator circuitry 220 based on configuration information, observation, etc.

Data stored in the region data store(s) 250-254 can then be provided to corresponding region user systems 260-264 for placing, processing, and fulfilling wagers, etc. Regional update(s) and/or other feedback from the data store(s) 250-254 can be provided to the odds generator circuitry 220 to adjust its operation and processing of market data, for example. Relevant data is routed to the regional systems 260-264 according to condition(s), criterion, other rules, etc., governing which data is provided to which region(s). In certain examples, the configuration console 240 works with a global positioning system (GPS) and/or other location system, a geofence, and/or rule(s) to determine which data, rules, betting opportunities, odds, etc., apply to which regional systems 260-264.

For example, a market and/or a betting opportunity for a market may be offered in one region but not another. For example, Russian table tennis games may be offered in Australia but not in the United States. Also, different regions may have different odds. For example, less generous odds may be offered on Australian Football League games in Australia compared to the odds offered for the same Australian Football League games in the United States. Such distinctions can be set by rules, parameters, settings from a configuration file, etc., stored and/or entered at the configuration console 240 and applied to the data feed management circuitry 235, which processes and distributes the data to the region data stores 250-254.

In certain examples, regional updates can be pushed from one or more region data stores 250-254 to the odds generator circuitry 220. For example, when a large amount of money has been wagered on a particular game in region one, the region one data store 250 communicates this back to the odds generator circuitry 220, which processes that feedback to recompute new market data (odds). The new odds/market data is routed by the data feed management circuitry 235 out to associated region data store(s) 250-254 to reflect the new information. The data store(s) 250-254 provide information to their respective user system(s) 260-264 to enable customers to choose an event and place bet and/or add an event/condition to a multiple or compound bet, for example.

In certain examples, odds can be represented using a model, such as a machine learning model, a data structure, and/or other representation. Market data can be provided to a model, and odds can be generated from the model, for example. In certain examples, one or more machine learning models can generate predictions in real time based on data from the data feed(s), regional update(s) from the data store(s) 250-254, etc. Factors such as player performance, weather, fan sentiment, timing, etc., can factor into a prediction of an outcome or an occurrence such as a final score, a margin of victory, an occurrence of an event in a game, etc. In certain examples, regional and/or other locational restrictions, regulations, or rules on odds, betting, market data, etc., can be applied as weighting on nodes and/or connections of a model, etc. In certain examples, one or more historical data feeds can be used to train a model, test a model, validate a model, etc. One or more current data feeds 205 can be used to provide feedback to retrain and/or otherwise update a model to be deployed to the odds generator circuitry 220, for example. Data feeds from a plurality of provider systems 205 can be used to help ensure robust, reliable model(s) trained and tested from multiple sources before being deployed for use, for example.

In certain examples, rather than utilizing a centralized server-based system, the odds generator circuitry 220 works with the data feed management circuitry 235 in a distributed network to maintain a distributed ledger (e.g., a blockchain, etc.) recording market data, associated odds, and a series of transactions or wagers associated with an event. For example, market data and associated odds for an American basketball game can form an initial record in a distributed ledger, and bets made on an outcome of that game can be added to the distributed ledger as the bets are made. A bet can be made and added as a record to the distributed ledger using a smart contract, for example. The smart contract can reflect the odds, wager amount, payout, and any limitations on the wager, for example. An outcome of the game and resulting settlement of the bets can be reflected, and verified, in the distributed ledger.

In certain examples, a quantitative or “quant” model can be formed using the market data to facilitate in-play wagering on a sporting event (including an esports event, non-sports event, etc.). Such a quant model can also support player proposition bets and facilitate bet building, etc. The model can be dynamically updated during an event. For example, the odds generator circuitry 220 can build a model based on data related to passing yards for a certain football player in a game. The model can adjust as the game progresses, based on game state, time decay, etc. Updated model output can be provided regionally to update current wagers, update odds, facilitate new in-play wagers, etc.

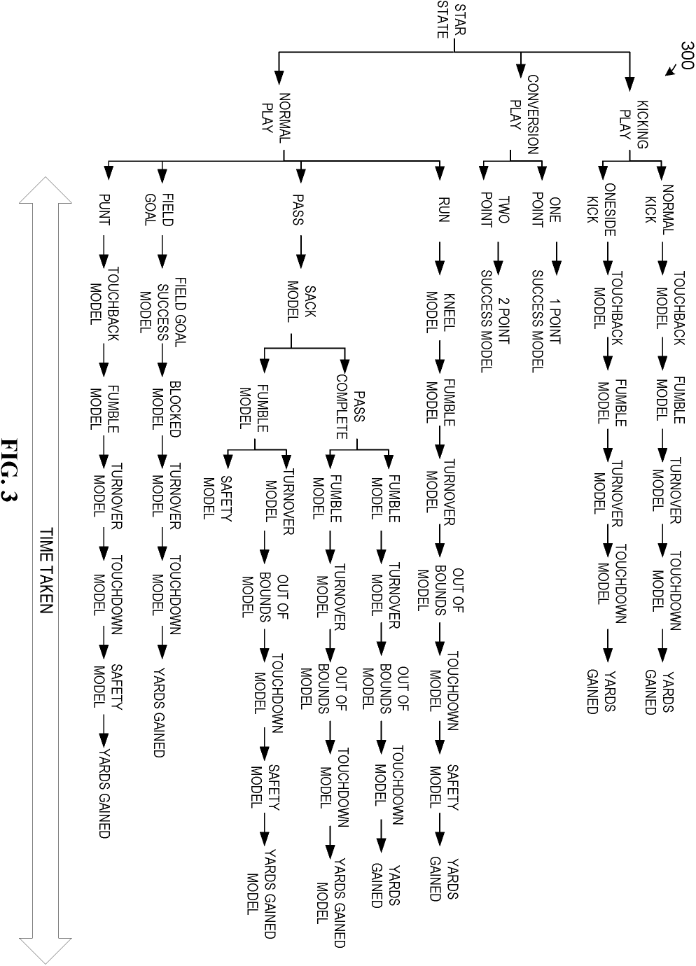

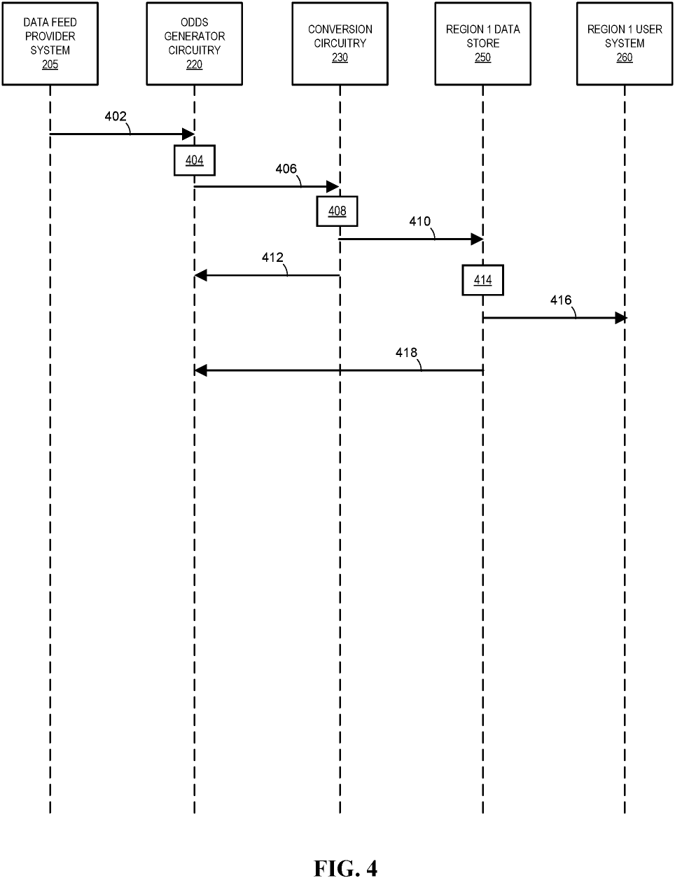

FIG. 3 depicts an example statistical model 300 generated for a National Football League (NFL) game. As shown in the example of FIG. 4, the example model 300 begins in a start state and advances over time during the game depending on a type of play, outcome of the play, etc. The example model 300 can form a tree of models or compound model and can trigger execution of a nested model depending on an outcome of an event being tracked in the game. As such, market data and associated odds evolve during the game for in-play wager opportunities. The model(s) 300 can be generated by the odds generator circuitry 220 and provided to the data feed management circuitry 235 for output to the region data store(s) 250-254 and associated region user system(s) 260-264, for example.

FIG. 4 depicts a data flow diagram illustrating an example flow or exchange 400 of instructions, commands, and data between elements of the example system 200, such as the data feed provider system(s) 205, the odds generator circuitry 220, the conversion circuitry 230, the region 1 data store 250, and the region 1 user system 260.

At 402, the data feed provider 205 sends an update of market data to the odds generator circuitry 220. At 404, the odds generator circuitry 220 processes the data feed using one or more statistical, quantitative, and/or artificial intelligence models to, at 406, provide an odds/market data output to the conversion circuitry 230. At 408, the conversion circuitry 230 processes the data to, at 410, provide a modified data output to the region 1 data store 250. For example, the conversion circuitry 230 can apply a location-based restriction on the data from the odds generator circuitry 220 according to a location of region 1 corresponding to the region 1 data store 250. At 412, the conversion circuitry 230 also provides feedback to the odds generator circuitry 220. For example, feedback from processing prior market/odds data by the conversion circuitry 230 can be provided to adjust modeling and/or other operation of the odds generator circuitry 220.

At 414, the region 1 data store 250 processes the data from the conversion circuitry 230 that is now stored in the data store 250 and, at 416, provides the data to the region 1 user system 260. The region 1 data store 250 also provides regional update feedback to the odds generator circuitry 220.

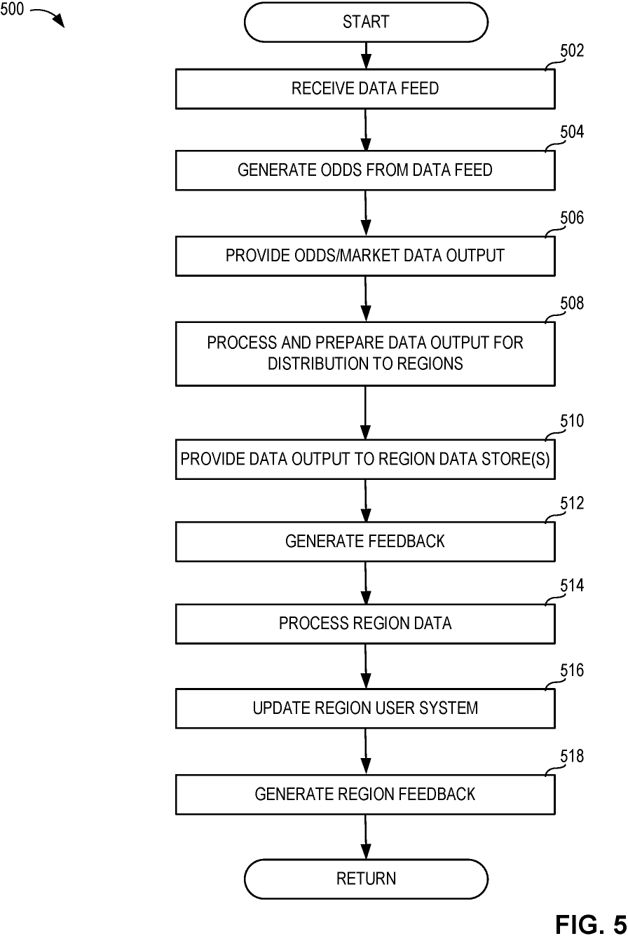

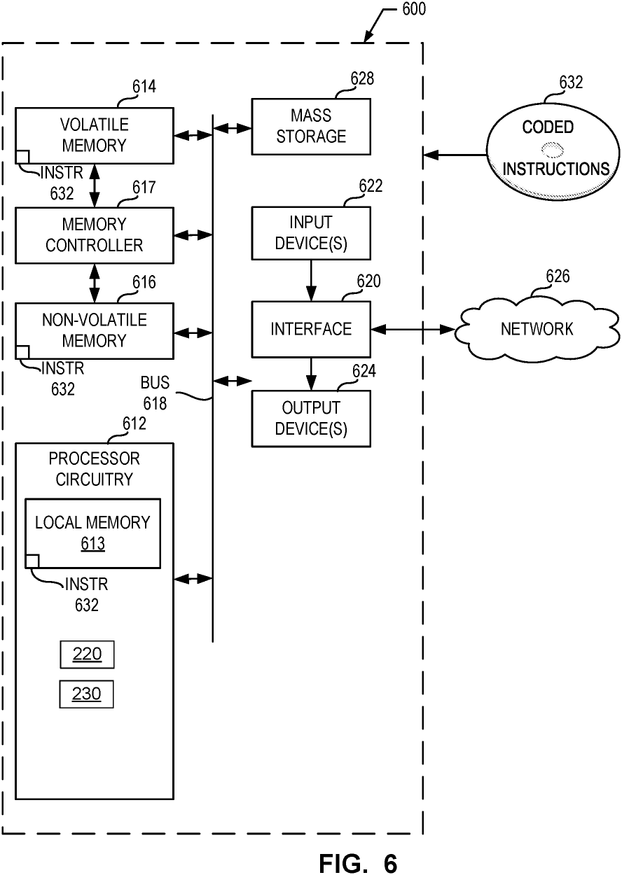

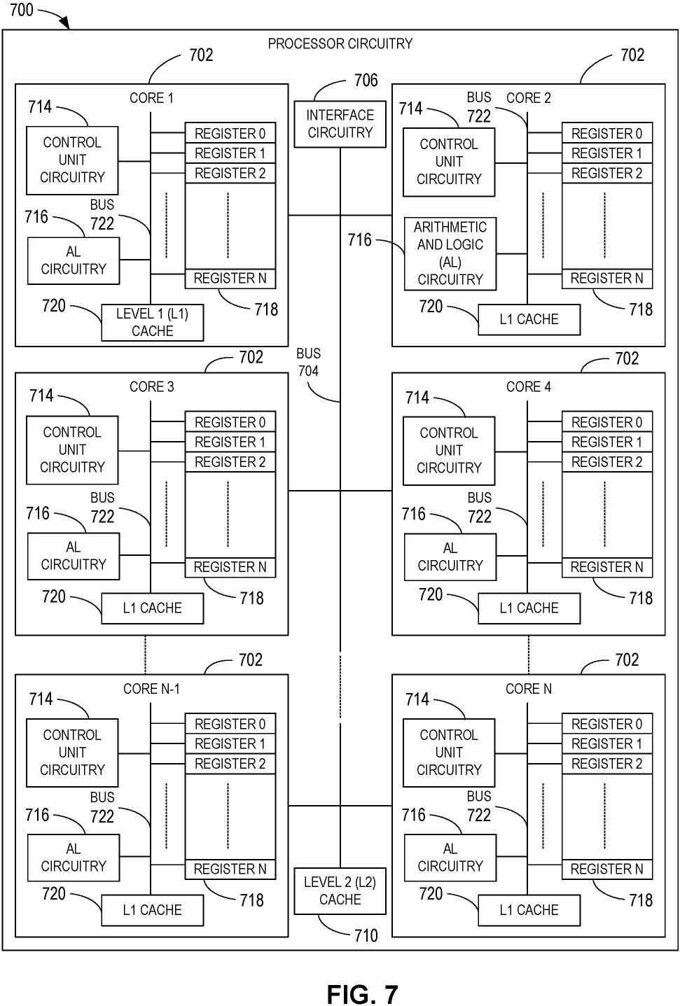

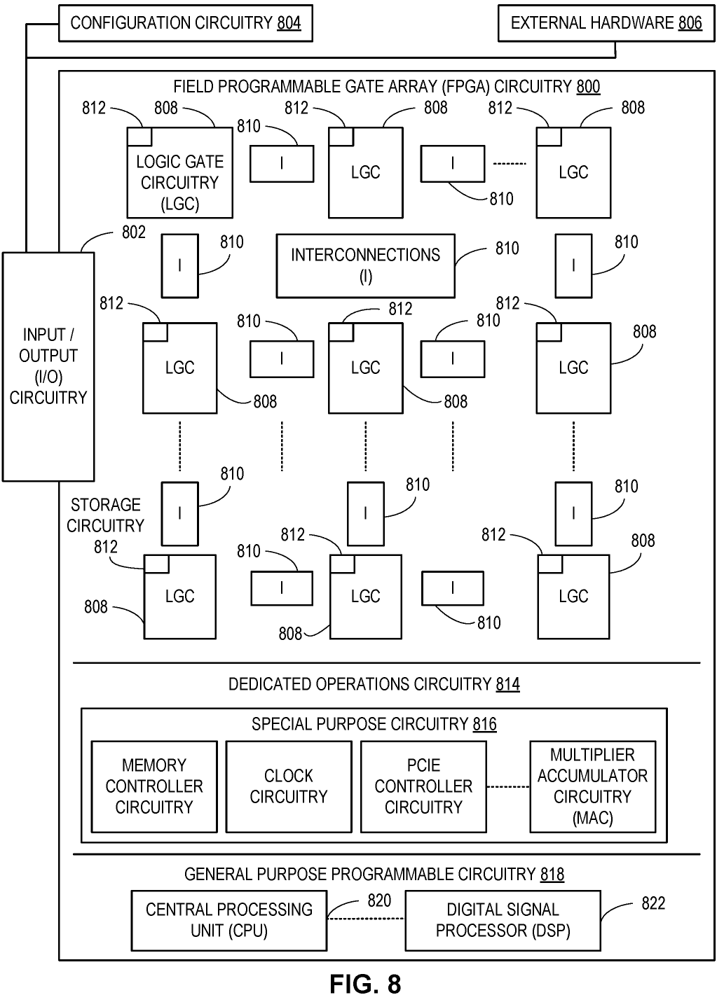

In some examples, the apparatus includes means for generating odds. For example, the means for generating odds may be implemented by odds generator circuitry 220. In some examples, the odds generator circuitry 220 may be implemented by machine executable instructions such as that implemented by at least blocks 502-506 of FIG. 5 executed by processor circuitry, which may be implemented by the example processor circuitry 612 of FIG. 6, the example processor circuitry 700 of FIG. 7, and/or the example Field Programmable Gate Array (FPGA) circuitry 800 of FIG. 8. In other examples, the odds generator circuitry 220 is implemented by other hardware logic circuitry, hardware implemented state machines, and/or any other combination of hardware, software, and/or firmware. For example, the odds generator circuitry 220 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for processing the odds and associated market data. For example, the means for processing odds and market data may be implemented by data feed management circuitry 235. In some examples, the data feed management circuitry 235 may be implemented by machine executable instructions such as that implemented by at least blocks 508-512 of FIG. 5 executed by processor circuitry, which may be implemented by the example processor circuitry 612 of FIG. 6, the example processor circuitry 700 of FIG. 7, and/or the example Field Programmable Gate Array (FPGA) circuitry 800 of FIG. 8. In other examples, the data feed management circuitry 235 is implemented by other hardware logic circuitry, hardware implemented state machines, and/or any other combination of hardware, software, and/or firmware. For example, the data feed management circuitry 235 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for providing regional updates. For example, the means for providing regional updates may be implemented by one or more of the region data stores 250-254. In some examples, the region data store(s) 250-254 may be implemented by machine executable instructions such as that implemented by at least blocks 514-518 of FIG. 5 executed by processor circuitry, which may be implemented by the example processor circuitry 612 of FIG. 6, the example processor circuitry 700 of FIG. 7, and/or the example Field Programmable Gate Array (FPGA) circuitry 800 of FIG. 8. In other examples, the odds generator circuitry 220 is implemented by other hardware logic circuitry, hardware implemented state machines, and/or any other combination of hardware, software, and/or firmware. For example, the region data store(s) 250-254 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example implementation of the architecture 200 is illustrated in FIG. 2, one or more of the elements, processes, and/or devices illustrated in FIG. 2 may be combined, divided, re-arranged, omitted, eliminated, and/or implemented in any other way. Further, the example odds generator circuitry 220, the example conversion circuitry 230 (including the example data feed management circuitry 235 and the configuration console 400), the example region data stores 250-254, and/or, more generally, the example architecture 200 of FIG. 2, may be implemented by hardware, software, firmware, and/or any combination of hardware, software, and/or firmware. Thus, for example, any of the example odds generator circuitry 220, the example conversion circuitry 230 (including the example data feed management circuitry 235 and the configuration console 400), the example region data stores 250-254, and/or, more generally, the example architecture 200, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example odds generator circuitry 220, the example conversion circuitry 230 (including the example data feed management circuitry 235 and the configuration console 400), and/or the example region data stores 250-254 is/are hereby expressly defined to include a non-transitory computer readable storage device or storage disk such as a memory, a digital versatile disk (DVD), a compact disk (CD), a Blu-ray disk, etc., including the software and/or firmware. Further still, the example A1 of FIG. 3 may include one or more elements, processes, and/or devices in addition to, or instead of, those illustrated in FIG. 4, and/or may include more than one of any or all of the illustrated elements, processes and devices.

A flowchart representative of example hardware logic circuitry, machine readable instructions, hardware implemented state machines, and/or any combination thereof for implementing the apparatus or architecture 200 of FIG. 2 is shown in FIG. 5. The machine readable instructions may be one or more executable programs or portion(s) of an executable program for execution by processor circuitry, such as the processor circuitry 612 shown in the example processor platform 600 discussed below in connection with FIG. 6 and/or the example processor circuitry discussed below in connection with FIG. 7 and/or 8. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 5, many other methods of implementing the example apparatus 50 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed and/or instantiated by processor circuitry to insert high level goal of flowchart. The machine readable instructions and/or operations 500 of FIG. 5 begin at block 502, at which input from one or more data feed providers 205 is provided to the odds generator circuitry 220. For example, a data feed provider 205 streaming national hockey league data provides box score information to the odds generator circuitry 220.

At block 504, when new data is received, the odds generator circuitry 220 processes the data feed using one or more statistical, quantitative, and/or artificial intelligence models to generate odds from the market data and formulate an informational feed to support betting operations. For example, a feed of tennis matches in progress and/or scheduled for the future can be processed by the odds generator circuitry 220 to associate particular odds with particular events (e.g., game outcomes, particular scores, player activity, etc.) in the data feed.

At block 506, the odds generator circuitry 220 provides an odds/market data output to the conversion circuitry 230. At block 508, the conversion circuitry 230 processes the data to prepare the data output for distribution to one or more regional data stores 250-254. For example, the data feed management circuitry 235 of the of the conversion circuitry 230 applies one or more rules, restrictions, etc., based on a location and/or other characteristic of region 1 corresponding to the region 1 data store 250, region 2 corresponding to the region 2 data store 252, region 3 corresponding to the region 3 data store 254, etc.

At block 510, the conversion circuitry 230 provides the data output to one or more of the region data store 250-254. For example, based on the determination by the data feed management circuitry 235 of which data applies and is to be provided to which region, the data feed management circuitry 235 of the conversion circuitry 230 provides the respective data to one or more of the region data stores 250-254. For example, different odds may be provided to different region data stores 250-254. Different betting opportunities may be provided to different region data stores 250-254, for example. Different market data may be provided to different region data stores 250-254, for example.

At block 512, the conversion circuitry 230 also provides feedback to the odds generator circuitry 220. For example, feedback from processing prior market/odds data by the conversion circuitry 230 can be provided to adjust modeling and/or other operation of the odds generator circuitry 220. Input from the configuration console 240 can also be provided and/or used to modify feedback to the odds generator circuitry 220.

At block 514, the receiving region data store(s) 250-254 process the data from the conversion circuitry 230. For example, each region data store 250-254 that receives data from the conversion circuitry 230 can process the data according to the format, protocol, preference, etc., of its associated region. The data is stored and prepared for transmission to and usage by the respective region user system 260-264, for example.

At block 516, one or more region data stores 250-254 provides a data update to their respective region user system 260-264. For example, each region data store 250-254 that received data from the conversion circuitry 230 provides an update to their associated region user system 260-264 to facilitate placement and monitoring of wagers.

At block 518, the region data store(s) 250-254 also provide regional update feedback to the odds generator circuitry 220. For example, if more than a threshold amount of money is being wagered on a particular game in a particular region, the region data store 250-254 can notify the odds generator circuitry 220, which uses the feedback to recompute new market data (odds), which is then pushed back to the relevant region data store(s) 250-254 to reflect the new market data.

Thus, the example data feed architecture apparatus or system 200 facilitates dynamic updating of market data and associated odds before and during an event, such as a sporting event, other event, etc. New data feed information is processed and distributed according to limitations and/or other rules, preferences, etc., associated with particular region(s), and feedback from one or more regions is processed to provide further data update to affected region(s). Such an architecture and associated data flow and instructions are not routine and conventional computing structure or functions. Further, such operations are not mental steps and cannot be performed in a human mind. Clearly, a human mind is not representative of the example architecture 200, and the example data feed architecture 200 represents a novel, nonobvious, and useful application of improved computer functionality and computing technology to leverage data feeds, models, regional rules/settings, and feedback to facilitate both shared distribution as well as selective distribution of changing data streams converted into odds and other market data from a plurality of regions.

FIG. 6 is a block diagram of an example processor platform 600 structured to execute and/or instantiate the machine readable instructions and/or operations of FIGS. 4-5 to implement the apparatus of FIG. 2. The processor platform 600 can be, for example, a server, a personal computer, a workstation, a self-learning machine (e.g., a neural network), a mobile device (e.g., a cell phone, a smart phone, a tablet such as an iPad™ , etc.), a personal digital assistant (PDA), an Internet appliance, a gaming console, an electronic gaming machine, a casino management system, or other computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements the example odds generator circuitry 220 and the example conversion circuitry 230.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output devices 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 632, which may be implemented by the machine readable instructions of FIGS. 4-5, may be stored in the mass storage device 628, in the volatile memory 614, in the non-volatile memory 616, and/or on a removable non-transitory computer readable storage medium such as a CD or DVD.

FIG. 7 is a block diagram of an example implementation of the processor circuitry 612 of FIG. 6. In this example, the processor circuitry 612 of FIG. 6 is implemented by a microprocessor 700. For example, the microprocessor 700 may implement multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowchart of FIG. 5.

The cores 702 may communicate by an example bus 704. In some examples, the bus 704 may implement a communication bus to effectuate communication associated with one(s) of the cores 702. For example, the bus 704 may implement at least one of an Inter-Integrated Circuit (I2C) bus, a Serial Peripheral Interface (SPI) bus, a PCI bus, or a PCIe bus. Additionally or alternatively, the bus 704 may implement any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2_ cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the L1 cache 720, and an example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The bus 720 may implement at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 8 is a block diagram of another example implementation of the processor circuitry 612 of FIG. 6. In this example, the processor circuitry 612 is implemented by FPGA circuitry 800. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor 700 of FIG. 7 described above (which is a general purpose device that may be programmed to execute some or all of the machine readable instructions represented by the flowchart of FIG. 5 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowchart of FIG. 5. In particular, the FPGA 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowchart of FIG. 5. As such, the FPGA circuitry 800 may be structured to effectively instantiate some or all of the machine readable instructions of the flowchart of FIG. 5 as dedicated logic circuits to perform the operations corresponding to those software instructions in a dedicated manner analogous to an ASIC. Therefore, the FPGA circuitry 800 may perform the operations corresponding to the some or all of the machine readable instructions of FIG. 5 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to obtain and/or output data to/from example configuration circuitry 804 and/or external hardware (e.g., external hardware circuitry) 806. For example, the configuration circuitry 804 may implement interface circuitry that may obtain machine readable instructions to configure the FPGA circuitry 800, or portion(s) thereof. In some such examples, the configuration circuitry 804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may implement the microprocessor 700 of FIG. 7. The FPGA circuitry 800 also includes an array of example logic gate circuitry 808, a plurality of example configurable interconnections 810, and example storage circuitry 812. The logic gate circuitry 808 and interconnections 810 are configurable to instantiate one or more operations that may correspond to at least some of the machine readable instructions of FIG. 5 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the processor circuitry 612 of FIG. 6, many other approaches are contemplated. For example, as mentioned above, modern FPGA circuitry may include an on-board CPU, such as one or more of the example CPU 820 of FIG. 8. Therefore, the processor circuitry 612 of FIG. 6 may additionally be implemented by combining the example microprocessor 700 of FIG. 7 and the example FPGA circuitry 800 of FIG. 8. In some such hybrid examples, a first portion of the machine readable instructions represented by the flowchart of FIG. 5 may be executed by one or more of the cores 702 of FIG. 7 and a second portion of the machine readable instructions represented by the flowchart of FIG. 5 may be executed by the FPGA circuitry 800 of FIG. 8.

In some examples, the processor circuitry 612 of FIG. 6 may be in one or more packages. For example, the processor circuitry 700 of FIG. 7 and/or the FPGA circuitry 700 of FIG. 7 may be in one or more packages. In some examples, an XPU may be implemented by the processor circuitry 612 of FIG. 6, which may be in one or more packages. For example, the XPU may include a CPU in one package, a DSP in another package, a GPU in yet another package, and an FPGA in still yet another package.

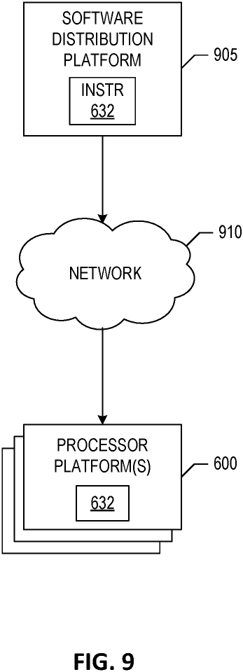

A block diagram illustrating an example software distribution platform 905 to distribute software such as the example machine readable instructions 632 of FIG. 6 to hardware devices owned and/or operated by third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions 500 of FIG. 5, as described above. The one or more servers of the example software distribution platform 905 are in communication with a network 910, which may correspond to any one or more of the Internet and/or any of the example networks 626 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions 500 of FIG. 5 may be downloaded to the example processor platform 600, which is to execute the machine readable instructions 632 to implement the example architecture 200. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices.

From the foregoing, it will be appreciated that example systems, methods, apparatus, and articles of manufacture have been disclosed that manages regional risk and transforms a data stream into different data sets with disparate impact on disparate regional systems. The disclosed systems, methods, apparatus, and articles of manufacture improve the efficiency of using a computing device to ensure up-to-date information and opportunities across regional systems by dynamically modeling odds and associated market data, accounting for in-play events to enable in-play opportunities, and create a feedback loop to synchronize regional data stores and associated systems while also treating regional data sets differently and separately. The disclosed systems, methods, apparatus, and articles of manufacture are accordingly directed to one or more improvement(s) in the operation of a machine such as a computer or other electronic and/or mechanical device. Certain examples provide a dynamic, updating, closed-loop architecture that remedies many deficiencies in prior systems that were not closed-loop, were not synchronized, and introduced uncertainty, discrepancies, outdated information, and disparities in outcome among multiple regions.

These elements described herein as part of the presently disclosed technology could not be implemented or performed before the internet or computer technology, nor can these elements be implemented or performed using only mental processes. None of the structures, functions, and/or features provided by the novel architecture are well-understood, routine or conventional.

As described above, an informational feed including games being/to be played of a certain type, starting lineups for the games, scores for gaming in progress, other events occurring in games in progress can be provided to the odds generator circuitry 220. The odds generator circuitry 220 processes the data feed using one or more models to generate odds, etc. The odds generator circuitry 220 provides the odds and associated market data to the data feed management circuitry 235.

The data feed management circuitry 235 processes the odds/market data to apply regional restrictions and/or other rules to customize the data for each region data store 250-254 and craft betting opportunities appropriate to each region using the data. For example, market/odds data for Kentucky can include horse racing opportunities, while market/odds data for India includes cricket. Odds for betting on college basketball games in the United States may differ from odds for betting on the same college basketball games in Europe. The data feed management circuitry 235, alone or in conjunction with the configuration console 240, can customize different sets of market/odds information to be provided to different region data stores 250254.

Each region data store 250-254 processes its data update and provides a resulting data set to an associated region user system 260-264 to facilitate wagering in that region. The region data store 250-254 can also provide regional updates and/or other feedback, such as amounts bet, number of bets, etc., back to the odds generator circuitry 220, which may adjust its models and/or associated odds based on the new information.

Additionally, as updates occur and new data feeds are provided by data provider(s) 205, the process continues to generate new odds, updated market data, and associated betting opportunities for the various connected regional systems 260-264, for example. For example, a player injury, a change in weather, a change in score, a result of another game, etc., can be provided by the data feed provider(s) 205 to trigger the odds generator circuitry 220 to generate new odds and provide updated information to the conversion circuitry 230 to update one or more affected regional data store(s) 250-254 and associated user system(s) 260-264. For example, an outcome of a related game may alter odds of a team clinching a playoff spot in a current game. An injury to a first player in a game affects odds of a winning outcome in that game and opens odds of scoring and/or other event for a second player replacing the first player in the game, for example. Dynamic processing and inclusion of data enables additional in-play opportunities not found in existing systems. Providing conversion circuitry including data feed management circuitry and a configuration console improves upon prior data feed designs by introducing the conversion circuitry to process the data according to regional rules, restrictions, preferences, etc., and provide separate, yet coordinated updates to a plurality of regions, while also enabling feedback to propagate and adjust the odds.

As such, dynamic updating of events enables the apparatus 200 to convert the event data into odds data associated with a particular market for a particular region.

Further aspects of the present disclosure are provided by the subject matter of the following clauses:

Example 1 is an apparatus including: odds generator circuitry to generate odds from a data feed using at least one model; data feed management circuitry to process data including the odds from the odds generator circuitry to apply one or more rules to generate at least a first data set including wagering opportunities for a first region and a second data set including wagering opportunities for a second region; and a plurality of region data stores including at least a first region data store to process and store the first data set and provide a first region update to the odds generator circuitry and a second region data store to process and store the second data set and provide a second region update to the odds generator circuitry, wherein at least one of the first region update or the second region update triggers the odds generator circuitry to re-generate the odds and output updated odds to the data feed management circuitry.

Example 2 includes the apparatus of any preceding clause, wherein the at least one model includes at least one of a statistical model or a quantitative model.

Example 3 includes the apparatus of any preceding clause, wherein the at least one model includes an artificial intelligence model.

Example 4 includes the apparatus of any preceding clause, further including a configuration console to adjust the processing of data by the data feed management circuitry.

Example 5 includes the apparatus of any preceding clause, wherein the configuration console is to adjust the generating of odds by the odds generator circuitry.

Example 6 includes the apparatus of any preceding clause, further including a plurality of region user systems including at least a first region user system to facilitate wagering in the first region using the first data set from the first region data store and a second region user system to facilitate wagering in the second region using the second data set from the second region data store.

Example 7 includes the apparatus of any preceding clause, wherein the data feed management circuitry is to manage synchronization of the plurality of region data stores in a closed loop system.

Example 8 includes the apparatus of any preceding clause, further including at least one data feed provider to generate the data feed.

Example 9 includes the apparatus of any preceding clause, further including a plurality of data feeds to be used by the odds generator circuitry to generate the odds and associated market data.

Example 10 includes the apparatus of claim 1, wherein a betting opportunity and associated wagers are maintained using a distributed ledger.

Example 11 is an apparatus including: memory circuitry to store instructions; and processor circuitry to execute the instructions to at least: generate odds from a data feed using at least one model; process data including the odds to apply one or more rules to generate at least a first data set including wagering opportunities for a first region and a second data set including wagering opportunities for a second region; process and store the first data set in a first region data store and the second data set in a second data store; provide at least one of a first region update or a second region update to the odds generator circuitry; provide the first data set to a first region user system to facilitate wagering in the first region; and provide the second data set to a second region user system to facilitate wagering in the second region.

Example 12 is he apparatus of any preceding clause, wherein the instructions, when executed, cause the processor circuitry to, in response to at least one of the first region update or the second region update, re-generate the odds and output updated odds.

Example 13 is the apparatus of any preceding clause, wherein the instructions, when executed, cause the processor circuitry to adjust the processing of data based on an external input.

Example 14 is the apparatus of any preceding clause, wherein the instructions, when executed, cause the processor circuitry to adjust the generating of odds.

Example 15 is the apparatus of any preceding clause, wherein the instructions, when executed, cause the processor circuitry to manage synchronization of a plurality of region data stores including the first region data store and the second region data store in a closed loop system.

Example 16 is at least one computer readable storage medium including instructions that, when executed, cause processor circuitry to at least: generate odds from a data feed using at least one model; process data including the odds to apply one or more rules to generate at least a first data set including wagering opportunities for a first region and a second data set including wagering opportunities for a second region; process and store the first data set in a first region data store and the second data set in a second data store; provide at least one of a first region update or a second region update to the odds generator circuitry; provide the first data set to a first region user system to facilitate wagering in the first region; and provide the second data set to a second region user system to facilitate wagering in the second region.

Example 17 includes the at least one computer readable storage medium of any preceding clause, wherein the instructions, when executed, cause the processor circuitry to, in response to at least one of the first region update or the second region update, re-generate the odds and output updated odds.

Example 18 includes the at least one computer readable storage medium of any preceding clause, wherein the instructions, when executed, cause the processor circuitry to adjust the processing of data based on an external input.

Example 19 includes the at least one computer readable storage medium of any preceding clause, wherein the instructions, when executed, cause the processor circuitry to adjust the generating of odds.

Example 20 includes the at least one computer readable storage medium of any preceding clause, wherein the instructions, when executed, cause the processor circuitry to manage synchronization of a plurality of region data stores including the first region data store and the second region data store in a closed loop system.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
odds generator circuitry to generate first odds from a data feed using at least one model, the at least one model trained using the data feed and deployed to generate the first odds;
data feed management circuitry to process data including the first odds from the odds generator circuitry to apply one or more rules to generate at least a first data set including wagering opportunities for a first region and a second data set including wagering opportunities for a second region; and
a plurality of region data stores including at least i) a first region data store to process and store the first data set, prepare the first data set for provisioning to a first region user system, and provide a first region update to the odds generator circuitry and ii) a second region data store to process and store the second data set, prepare the second data set for provisioning to a second region user system, and provide a second region update to the odds generator circuitry,
wherein at least one of the first region update or the second region update triggers the odds generator circuitry to re-generate the first odds to form second odds and output the second odds to the data feed management circuitry.

2. The apparatus of claim 1, wherein the at least one model includes at least one of a statistical model or a quantitative model.

3. The apparatus of claim 1, wherein the at least one model includes an artificial intelligence model.

4. The apparatus of claim 1, further including a configuration console to adjust the processing of data by the data feed management circuitry.

5. The apparatus of claim 4, wherein the configuration console is to adjust the generating of at least one of the first odds or the second odds by the odds generator circuitry.

6. The apparatus of claim 1, further including a plurality of region user systems including at least the first region user system to facilitate wagering in the first region using the first data set from the first region data store and the second region user system to facilitate wagering in the second region using the second data set from the second region data store.

7. The apparatus of claim 1, wherein the data feed management circuitry is to manage synchronization of the plurality of region data stores in a closed loop system.

8. The apparatus of claim 1, further including at least one data feed provider to generate the data feed.

9. The apparatus of claim 1, further including a plurality of data feeds to be used by the odds generator circuitry to generate the first odds and associated market data.

10. The apparatus of claim 1, wherein a betting opportunity and associated wagers are maintained using a distributed ledger.

11. An apparatus comprising:
memory circuitry to store instructions; and
processor circuitry to execute the instructions to at least:
generate first odds from a data feed using at least one model, the at least one model trained using the data feed and deployed to generate the first odds;
process data including the first odds to apply one or more rules to generate at least a first data set including wagering opportunities for a first region and a second data set including wagering opportunities for a second region;
process and store the first data set in a first region data store and the second data set in a second data store;
provide at least one of a first region update or a second region update to the odds generator circuitry;
provide the first data set to a first region user system to facilitate wagering in the first region;
provide the second data set to a second region user system to facilitate wagering in the second region; and
in response to at least one of the first region update or the second region update, re-generate the first odds to form second odds and output the second odds.

12. (canceled)

13. The apparatus of claim 11, wherein the instructions, when executed, cause the processor circuitry to adjust the processing of data based on an external input.

14. The apparatus of claim 11, wherein the instructions, when executed, cause the processor circuitry to adjust the generating of at least one of the first odds or the second odds.

15. The apparatus of claim 11, wherein the instructions, when executed, cause the processor circuitry to manage synchronization of a plurality of region data stores including the first region data store and the second region data store in a closed loop system.

16. At least one non-transitory computer readable storage medium comprising instructions that, when executed, cause processor circuitry to at least:
generate first odds from a data feed using at least one model, the at least one model trained using the data feed and deployed to generate the first odds;
process data including the first odds to apply one or more rules to generate at least a first data set including wagering opportunities for a first region and a second data set including wagering opportunities for a second region;
process and store the first data set in a first region data store and the second data set in a second data store;
provide at least one of a first region update or a second region update to the odds generator circuitry;
provide the first data set to a first region user system to facilitate wagering in the first region;
provide the second data set to a second region user system to facilitate wagering in the second region; and
in response to at least one of the first region update or the second region update, re-generate the first odds to form second odds and output the second odds.

17. (canceled)

18. The at least one computer readable storage medium of claim 16, wherein the instructions, when executed, cause the processor circuitry to adjust the processing of data based on an external input.

19. The at least one computer readable storage medium of claim 16, wherein the instructions, when executed, cause the processor circuitry to adjust the generating of at least one of the first odds or the second odds.

20. The at least one computer readable storage medium of claim 16, wherein the instructions, when executed, cause the processor circuitry to manage synchronization of a plurality of region data stores including the first region data store and the second region data store in a closed loop system.

21. The apparatus of claim 1, wherein at least one of the first region update or the second region update is used to retrain the at least one model.
